(19) United States
(12) Patent Application Publication
(10) Pub. No.: US 2004/0017091 A1
(43) Pub. Date: Jan. 29, 2004

(54) Dismountable seat for an automobile capable of being automatically tumbled and mounted in a face-to-face manner

(75) Inventors: Jae-Myung Hur, Anyang-Si (KR); Ki-Jong Park, Ansan-Si (KR)

Correspondence Address: ARENT FOX KINTNER PLOTKIN & KAHN, 1050 CONNECTICUT AVENUE, N.W., SUITE 400, WASHINGTON, DC, 20036, US

(73) Assignee: DAE WON Industries Co., Ltd.

(21) Appl. No.: 10/252,367

(22) Filed: Sep. 24, 2002

(30) Foreign Application Priority Data
Jul. 27, 2002 (KR) 44417/02

(51) Int. Cl. B60N 2/02

(52) U.S. Cl. 296/65.03; 296/65.13

(57) ABSTRACT

A seat for an automobile, which is intended to reduce its weight and to be easily mounted and dismounted by having a seat sliding device mounted on a body frame rather than a seat frame and having rollers, and which can be automatically tumbled and mounted face to face with other seats by a spiral spring and a locking structure by engagement at two points, is disclosed. The seat includes a front lock plate coupled to a front end of a seat frame by a front link to lock a front portion of a seat, a rear lock plate coupled to a rear end of the seat frame by a rear link to lock a rear portion of the seat, a lock plate link connected between the front lock plate and the rear lock plate to be rotated upon releasing the locked condition of the rear lock plate, a long slide rail coupled between the front and rear lock plates and received in a long slide channel mounted on a body frame to be moved therealong, which includes front and rear pairs of strikers to allow the seat frame to be mounted on or dismounted from the body frame, and on which the front and rear portions of the seat are locked, and a sliding lock-releasing unit connected to the long slide rail to release the locked condition of the seat frame, allowing the seat frame to be slid.

### BACKGROUND OF THE INVENTION

1. Field of the Invention

The present invention relates to a seat for an automobile, and more particularly to a seat for an automobile which is capable of being automatically tumbled by a spiral spring and a locking structure employing engagement at two points, and is capable of being mounted face to face with other seats, and which is intended to reduce its weight by its sliding device being mounted on a vehicle body frame rather than a seat frame, thereby facilitating its mounting and dismounting operations, and is easily moved by its rollers after being dismounted.

2. Description of the Prior Art

In general, seats for an automobile serve to absorb vibration caused by unevenness of a roadway and thus alleviate user's fatigue, thereby affording a comfortable feeling to a driver. Since the seats occupy a considerable proportion of the weight and production cost of an automobile, the seats are required to have a light and economical construction. Furthermore, the seats must be designed to have shapes and sizes such that all passengers seated thereon can be satisfied. In addition, since the seats occupy a major proportion of an interior space of an automobile, the seats must also satisfy drivers and passengers in terms of interior design.

When there is a need to load a large volume of goods on rear seats of an automobile, back rests of the seats must be folded on to their seat parts to provide a space sufficient to accommodate the goods. However, where the volume of the goods is relatively large, the goods interfere with the seats and inner surfaces of the automobile. Accordingly, it is impossible to load the goods in a stable state, and the loading operation is also considerably inconvenient.

To overcome the above problems, a rear seat has been proposed, which is designed to be dismountably mounted on an automobile. In the proposed rear seat, a seat frame attached to a lower surface of the seat is provided at its front end with an insert holding member having a coupling element and is provided at its rear end with a second holding member having an elastic ball stopper. To allow the insert holding member to be dismountably mounted, a locking unit, which is comprised of a locker and a housing receiving a link for moving the locker, is mounted on a floor panel. To allow the second holding member to be dismountably mounted, a striker is mounted on the floor panel. However, when there is a need to transfer the dismounted seat, since a user has to transfer the relatively heavy seat to a desired location by using only his strength, it is difficult or impossible for the aged and the disabled to handle or store the dismounted seat.

### SUMMARY OF THE INVENTION

Accordingly, the present invention has been made keeping in mind the above problems occurring in the prior art, and an object of the present invention is to provide a seat for an automobile which is capable of being automatically tumbled by a spiral spring and a locking structure employing engagement at two points, and is capable of being mounted face-to-face with other seats, and which is intended to reduce its weight by its sliding device being mounted on a behicle body frame rather than a seat frame, thereby facilitating its mounting and dismounting operations, and is easily moved by its rollers after being dismounted.

In order to accomplish the above object, the present invention provides a dismountable seat for an automobile which is adapted to be automatically tumbled and mounted face to face with other seats, the dismountable seat comprising: a front lock plate operatively coupled to a front end of a seat frame by a front actuating link and adapted to lock a front portion of a seat; a rear lock plate operatively coupled to a rear end of the seat frame by a rear actuating link and adapted to lock a rear portion of the seat; a lock plate link connected between the front lock plate and the rear lock plate and adapted to be rotated upon releasing the locked condition of the rear lock plate; a long slide rail coupled between the front and rear lock plates and received in a long slide channel mounted on a body frame to be moved therealong, which includes front and rear pairs of strikers to allow the seat frame to be mounted on or dismounted from the body frame, and on which the front and rear portions of the seat are locked; and a sliding lock-releasing unit connected to the long slide rail, which is adapted to release the locked condition of the seat frame to allow the seat frame to be slid.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a side view of a dismountable seat for an automobile according to the present invention;

FIG. 2 is a side view of a seat frame shown in FIG. 1, which is dismounted from a slide rail;

FIG. 3 shows a long slide rail according to the present invention;

FIG. 4 is a side view of a front lock plate according to the present invention;

FIG. 5 is a side view of a rear lock plate according to the present invention;

FIG. 6 is a side view of a slide-locking device of the long slide rail according to the present invention;

FIG. 7 is a side view showing components of a sliding lock-releasing unit according to the present invention; and

FIGS. 8a to 8c show a mounting operation of the dismountable seat according to the present invention.

### DETAILED DESCRIPTION OF THE INVENTION

This invention will be described in further detail by way of example with reference to the accompanying drawings.

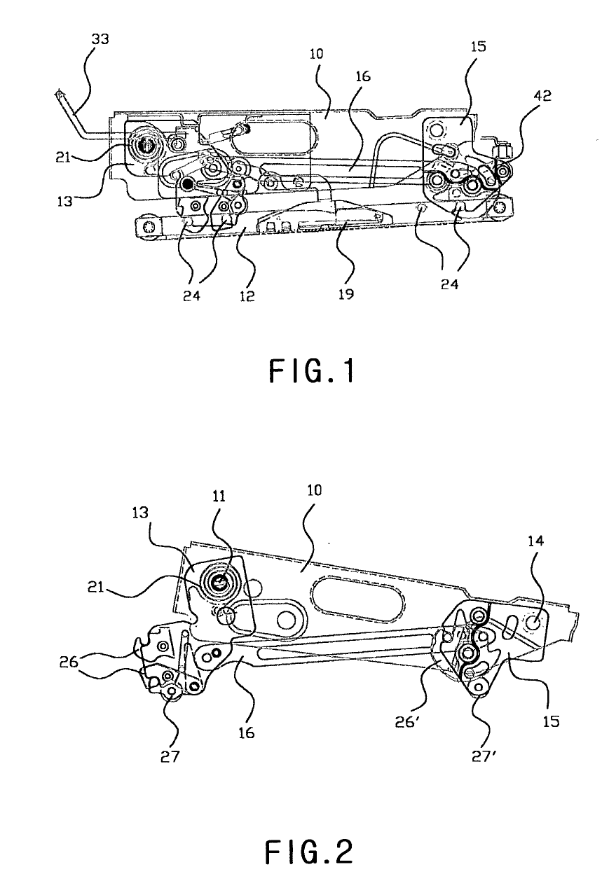

FIG. 1 is a schematic view showing a dismountable seat according to the present invention. As shown in the drawing, the dismountable seat according to the present invention comprises a pair of front lock plates 13 operatively coupled to both sides of a front end of a seat frame 10 by a front actuating link 11 and adapted to lock a front portion of a seat on long slide rails 12, a pair of rear lock plates 15 operatively coupled to both sides of a rear end of the seat frame 10 by a rear actuating link 14 and adapted to lock a rear portion of the seat on the long slide rails 12, a pair of lock plate links 16 connected between the front lock plates 13 and the rear lock plates 15 and adapted to be rotated upon releasing the locked condition of the rear lock plates 15, the long slide rails 12 coupled between the front and rear lock plates 13 and 15 and received in long slide channels 18 mounted on a body frame 10 to be moved therealong, and a sliding lock-releasing unit 20 connected to a slide locking device 19 of the long slide rails 12, which is adapted to release the locked condition of the seat frame 10 to allow the seat frame 10 to be slid.

The front lock plates 13 are operatively coupled to both sides of the seat frame 10 by the front actuating link 11 to lock the front end of the seat on the long slide rails 12. The rear lock plates 15 are operatively coupled to both sides of the seat frame 10 by a rear actuating link 14 and adapted to lock a rear portion of the seat on the long slide rails 12. The lock plate links 16 are connected between the front lock plates 13 and the rear lock plates 15, and adapted to be rotated about hinges positioned at the front lock plates 13, thereby allowing the seat to be tumbled by a spiral spring, upon releasing the locked condition of the rear lock plates 15.

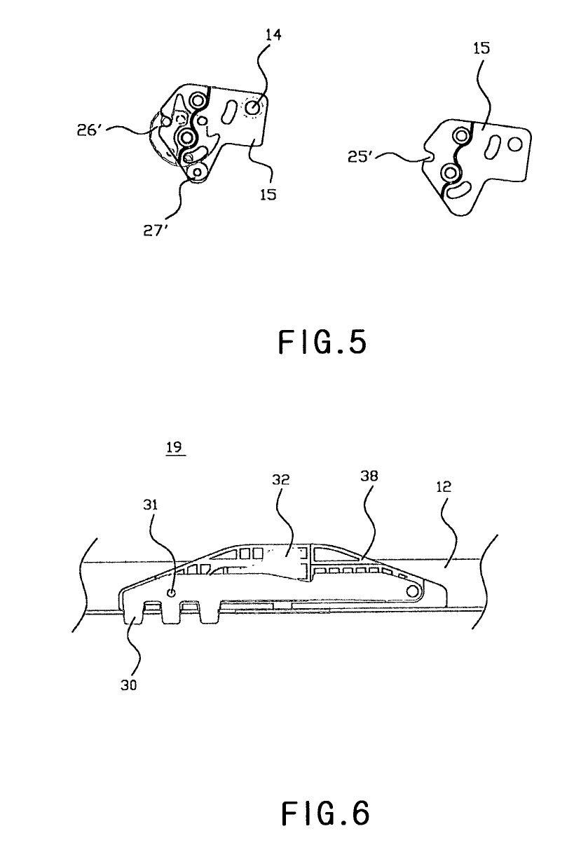

FIG. 2 shows the seat frame shown in FIG. 1, which is dismounted from the body frame, FIG. 4 shows components of the front lock plate according to the present invention, and FIG. 5 shows components of the rear lock plate according to the present invention.

As shown in the drawings, each of the front lock plates 13 includes a spiral spring 21 for rotating the seat frame 10 upon releasing the rear locked condition, a holding hole 23 for holding an end of the spiral spring 21, guide cut portions 25 to be engaged with front strikers 24 of the long slide rail 12, locking pieces 26 to be engaged with the front strikers 24 to lock the seat frame 10, and a roller 27 for allowing the seat to be easily moved at the time of or after release of the locked conditions of the locking pieces 26.

By the spiral spring 21 which is fitted over the front actuating link 11 and caught by the holding hole 23 at its end, seat frame 10 can be automatically tumbled when the locked condition of the locking pieces 26 is released, and thus the seat can be dismounted from the body frame by actuating the locking pieces 26 by a dismounting lever 41. At this point, a roller 27 is lowered downwardly to allow the seat to be easily moved.

Each of the rear lock plate 15 includes a guide cut portion 25′ to be engaged with rear strikers 24 of the long slide rail 12, a locking piece 26′ to be engaged with the rear strikers 24 to lock the seat frame 10, a roller 27′ adapted to allow the seat to be easily moved when or after the locking piece 26′ is released, and a rear lock-releasing lever 42.

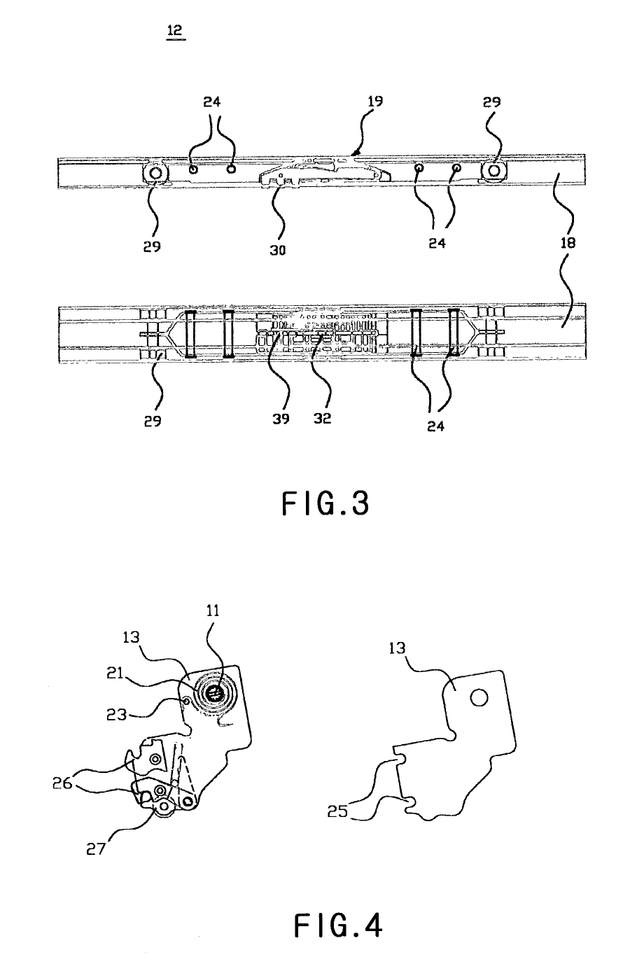

As shown in FIG. 3, each of the long slide rails 12 includes the slide locking device 19 adapted to lock the seat frame 10 to prevent its sliding movement, two pairs of strikers 24 to be engaged with the locking pieces 26 of the front lock plate 13 and the locking piece 26′ of the rear lock plate 15 and to allow the seat frame to be dismounted from the body frame, and a pair of slide rollers 29 provided at the opposite ends of the long slide rail 12 to allow the long slide rail 12 to be moved on the long slide channel 18.

The two pairs of strikers 24, which are positioned at the opposite ends of the long slide rail 12, are designed such that both the pair of front strikers 24 are engaged with the two locking pieces 26 of the front lock plate 13 and only one of the pair of rear strikers 24 is engaged with the one locking piece 26′ of the rear lock plate 15. This enables the seat frame to be dismounted and tumbled and strength of the seat frame to be increased.

FIG. 6 is a schematic view of the slide-locking device of the long slide rail according to the present invention. As shown in the drawing, the slide locking device 19 includes a locking arm 30 for locking the slide locking device 19, and a reaction bar 32 hingedly connected to the locking arm 30 and actuated by the sliding lock-releasing unit 20 provided at the seat frame.

The reaction bar 32 serves to raise the locking arm 30 locking the long slide rail about a hinge pin 31 by force transmitted from a second link 37 of the sliding lock-releasing unit 20.

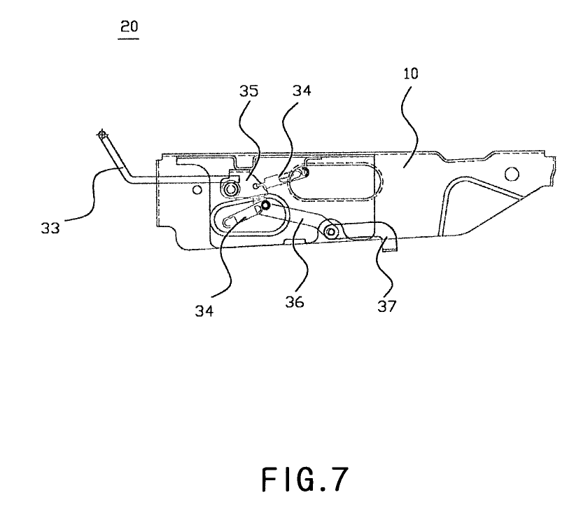

FIG. 7 schematically shows components of the sliding lock-releasing unit 20 according to the present invention. As shown in the drawing, the sliding lock-releasing unit 20 includes a sliding lever 33 for releasing the slide locked condition of the long slide rail 12, a joint 35 adapted to be actuated by pulling action of the sliding lever 33 and restored by a spring 34 connected to the seat frame 10, a first link 36 engaged with an end of the joint 35 to be actuated, and the second link 37 adapted to be actuated by the first link 36 and to apply force transmitted from the first link 36, to the reaction bar 32 of the sliding lock device 19.

More specifically, when a user pulls the sliding lever 33, the joint 35 is rotated downwardly. The downward movement of the joint 35 causes the engaged end of the first link 36 to be pushed, and thus the opposite end of the first link 36 is raised. Consequently, the end of the second link 37, which is connected to the opposite end of the first link 36, is raised and thus the opposite end of the second link 37 is lowered, thereby pushing the reaction bar 32 of the sliding lock device 19.

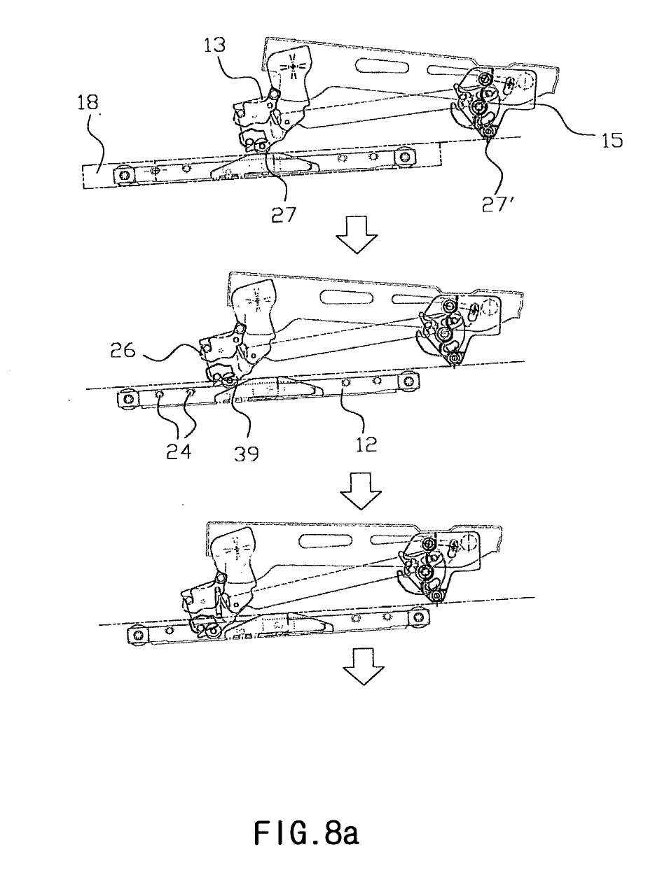

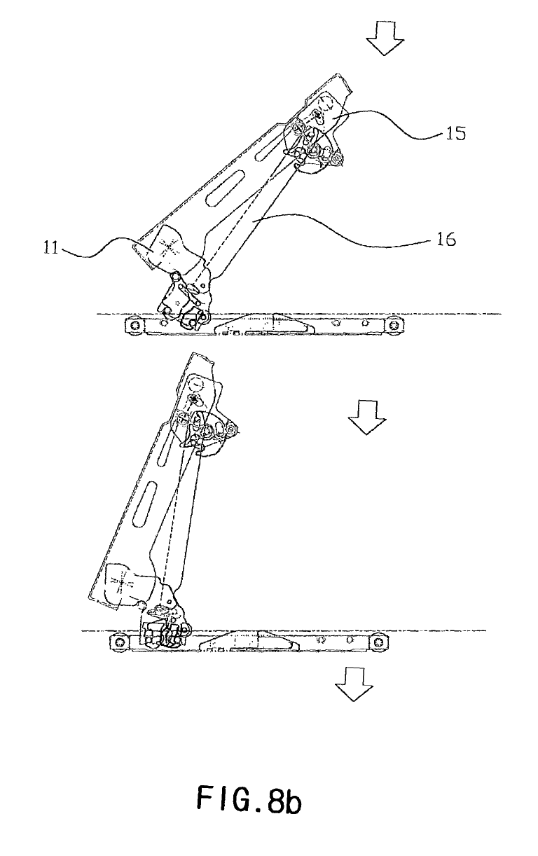

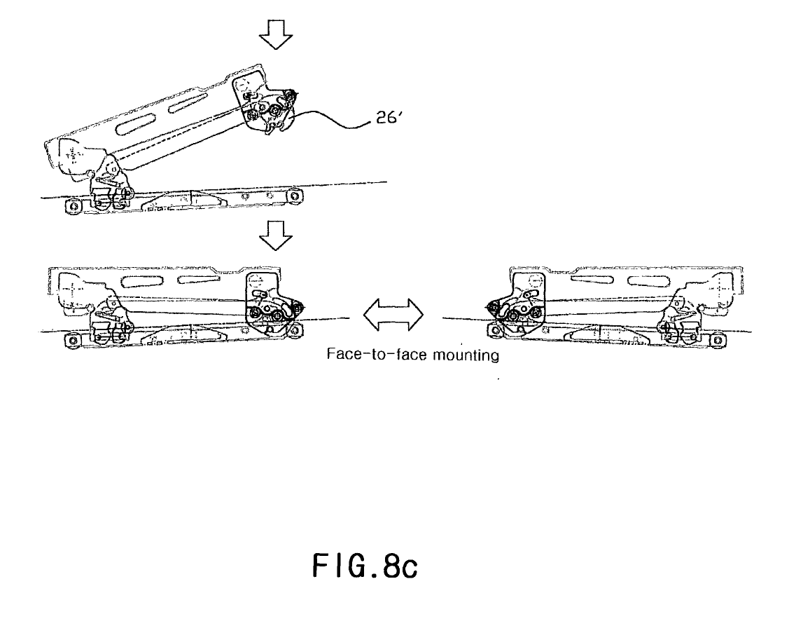

FIGS. 8a to 8c show a mounting operation of the dismountable seat according to the present invention. As illustrated in the drawings, the rollers 27 and 27′ of the front and rear lock plates 13 and 15 are moved to the front pair of strikers 24 along a roller guide 39 received in the long slide channel 18, and the locking pieces 26 of the front lock plate 13 are engaged with the pair of front strikers 24. At this point, the seat frame 10 is in the erect position. Subsequently, as the seat frame 10 is rotated about the front actuating link 11, the lock plate link 16 is moved rearwardly. By the rearward movement of the lock plate link 16, the rear lock plate 15 is extended outwardly. As result, the locking piece 26′ of the rear lock plate 15 is engaged with one of the pair of rear strikers 24. In this state, the seat frame 10 is biased to be tumbled by the spiral spring 21, so that the seat frame 10 is automatically tumbled by actuation of the rear lock-releasing lever 42.

In an operation of moving the seat frame, the user pulls the sliding lever 33 to rotate the joint 35 downwardly. The end of the first link 36 is pushed by the downward movement of the joint 35, and thus the opposite end of the first link 36 is raised. The opposite end of the second link 37 is lowered, and thus the reaction bar 32 of the sliding lock device 19 is pushed downwardly. By the downward movement of the reaction bar 32, the locking arm 30 is raised and thus allows the seat frame to be moved.

As described above, the present invention provides a dismountable seat, which is capable of being automatically tumbled and being mounted face to face with other seats. A seat frame of the seat can be locked on a long slide rail and the seat can be automatically tumbled, by two pairs of strikers and a spiral spring. Since a seat-sliding device is mounted on a body frame rather than a seat frame, a weight of the seat is reduced, thereby facilitating mounting and dismounting operations of the seat. In addition, since the seat is provided with rollers, the dismounted seat can be easily transferred and stored by the aged and the disabled.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A dismountable seat for an automobile which is adapted to be automatically tumbled and mounted face to face with other seats, the dismountable seat comprising:
a front lock plate operatively coupled to a front end of a seat frame by a front actuating link and adapted to lock a front portion of a seat;
a rear lock plate operatively coupled to a rear end of the seat frame by a rear actuating link and adapted to lock a rear portion of the seat;
a lock plate link connected between the front lock plate and the rear lock plate and adapted to be rotated upon releasing the locked condition of the rear lock plate;
a long slide rail coupled between the front and rear lock plates and received in a long slide channel mounted on a body frame to be moved therealong, which includes front and rear pairs of strikers to allow the seat frame to be mounted on or dismounted from the body frame, and on which the front and rear portions of the seat are locked; and
a sliding lock-releasing unit connected to the long slide rail, which is adapted to release the locked condition of the seat frame to allow the seat frame to be slid.

2. The dismountable seat as set forth in claim 1, wherein the front lock plate includes a spiral spring for rotating the seat frame upon releasing the rear locked condition, a holding hole for holding an end of the spiral spring, guide cut portions to be engaged with the front pair of strikers of the long slide rail, locking pieces to be engaged with the front strikers to lock the seat frame, and a roller for allowing the seat to be easily moved at the time of or after release of the locked conditions of the locking pieces.

3. The dismountable seat as set forth in claim 1, wherein the rear lock plat includes a guide cut portion to be engaged with one of the rear pair of strikers of the long slide rail, a locking piece to be engaged with the one of the rear pair of strikers to lock the seat frame, and a roller adapted to allow the seat to be easily moved when or after the locking piece is released.

4. The dismountable seat as set forth in claim 1, wherein the long slide rail includes a slide locking device provided at the long slide rail and adapted to lock the seat frame to prevent its sliding movement, and a pair of slide rollers provided at the opposite ends of the long slide rail to allow the long slide rail to be moved on the long slide channel.

5. The dismountable seat as set forth in claim 4, wherein the slide locking device includes a locking arm for locking the slide locking device, and a reaction bar hingedly connected to the locking arm and actuated by the sliding lock-releasing unit provided at the seat frame.

6. The dismountable seat as set forth in claim 1, wherein the sliding lock-releasing unit includes a sliding lever for releasing the slide locked condition of the long slide rail, a joint adapted to be actuated by pulling action of the sliding lever and restored by a spring connected to the seat frame, a first link engaged with an end of the joint to be actuated, and the second link adapted to be actuated by the first link and to apply force transmitted from the first link, to the reaction bar of the sliding lock device.

7. The dismountable seat as set forth in claim 1, wherein the mounting of the seat is achieved by an operation comprising: moving the rollers of the front and rear lock plates toward the front pair of strikers along a roller guide received in the long slide channel; engaging the locking pieces of the front lock plate with the pair of front strikers such that the seat frame is erected; rotating the seat frame about the front actuating link to cause the lock plate link to be moved rearwardly and to cause the rear lock plate to be extended outwardly; and engaging the locking piece of the rear lock plate with one of the pair of rear strikers, wherein the tumbling of the seat is achieved by actuating the rear lock-releasing lever to allow the seat frame biased by the spiral spring to be automatically tumbled, wherein the displacement of the seat is achieved in such a way that the sliding lever is pulled by a user to rotate the joint downwardly, the end of the first link is pushed while the opposite end of the first link is raised by the downward movement of the joint, the opposite end of the second link is lowered by the upward movement of the opposite end of the first link, the reaction bar of the sliding lock device is pushed downwardly by the downward movement of the opposite end of the second link, and the locking arm is raised and thus allows the seat frame to be moved by the downward movement of the reaction bar.
